(19) United States
(12) Patent Application Publication
(10) Pub. No.: US 2024/0196436 A1
(43) Pub. Date: Jun. 13, 2024

(54) SYSTEM AND METHODS FOR MITIGATING OUT-OF-BAND INTERFERENCE IN C-V2X TRANSMISSIONS

(71) Applicant: Autotalks Ltd., Kfar Netter (IL)

(72) Inventor: Onn Haran, Kfar Netter (IL)

(21) Appl. No.: 18/501,291

(22) Filed: Nov. 3, 2023

Related U.S. Application Data
(60) Provisional application No. 63/386,322, filed on Dec. 7, 2022.

(51) Int. Cl. H04W 74/08

(52) U.S. Cl. CPC H04W 74/0816; H04W 84/12

(57) ABSTRACT

System and methods for mitigating out-of-band (OOB) interference in C-V2X transmissions. The system may comprise a V2X modem for transmitting and receiving messages, an OOB energy detection unit for detecting OOB energy transmitted by a nearby WiFi transmitter inside the C-V2X band, a one-time allocation identification unit for tracking a resources map to identify a one-time allocation, and an enhanced resource reservation algorithm and modulation coding scheme (MCS) setting unit for configuring the V2X modem for transmission based on detected OOB energy and the resources map. The methods may set a MCS value while accounting for OOB interference detection and mitigation or may enhance resource reservation while accounting for OOB interference detection and mitigation.

### CROSS REFERENCE TO RELATED APPLICATIONS

This application claims the benefit of priority from U.S. Provisional patent application No. 63/386,322 filed Dec. 7, 2022, which is incorporated herein by reference in its entirety.

### FIELD

Embodiments disclosed herein relate generally to an enhanced C-V2X (cellular vehicle-to-everything) system and methods that mitigate out-of-band interference, and in particular, to a C-V2X system and method that minimize transmitted interferences of self and nearby vehicles after detecting out-of-band interference from a nearby WiFi access point.

### BACKGROUND

The spectrum allocation of V2X in the US, as illustrated in FIG. 1A, is prone to interference. The V2X band (104) is located between 5.895 GHz and 5.925 GHz. Unlicensed WiFi devices may be transmitting adjacent to it in the U-NII-4 (102) and U-NII-5 (106) bands.

All transmitters emit out-of-band (OOB) noise. The OOB emissions of U-NII-4 and U-NII-5 transmitters are illustrated in FIG. 1B. The Y-axis shows the transmitted power level 108. The unlicensed device transmission in U-NII-4 110 emits OOB 112 in the V2X band. The unlicensed device transmission in U-NII-5 114 emits OOB 116 inside the V2X band. The major OOB interference contribution comes from the U-NII-4 band, which has loose OOB regulatory requirements. The OOB increases the noise in the V2X band and lowers the communication range.

FIG. 1C illustrates schematically a scenario in which vehicles are impacted by WiFi interference. The figure illustrates two vehicles, 122 and 124, next to house 126. Each of the vehicles acts as “self-vehicle” when performing a method disclosed herein. The house contains a WiFi device 128, either access point or client. Vehicle 122 is within a range 130 of device 128, the transmission of which causes OOB interference for vehicle 122. As a result, vehicle 122 might fail to receive distant vehicles, like vehicle 124. Vehicle 124 is outside WiFi range 130, and hence not aware of the interference.

There is therefor a need to adjust the transmissions of both self vehicles and other vehicles to mitigate detected OOB interferences.

### SUMMARY

In some examplary embodiments, there are provided methods for setting a MCS value while accounting for OOB interference detection and mitigation, comprising: by a self-vehicle and in each slot of a C-V2X communication band: checking if transmission (TX) is planned in a particular slot during a slot duration; if TX is not planned in the particular slot during the slot duration, checking if OOB interference is detected while receiving a message in the particular slot; if OOB interference is not detected while receiving the message in the particular slot, checking if the received message is a one-time allocation; and, if the received message is a one-time allocation, setting a MCS value lower than a regular MCS value to increase the resilience to the OOB interference.

In some examples, the OOB interference may be caused by WiFi transmission in the U-NII-4 band. In some examples, the OOB interference may be caused by WiFi transmission in the U-NII-5 band.

In some examples, if the received message is a one-time allocation, a method includes setting the regular MCS value.

In some examples, if TX is planned in the particular slot during the slot duration, a method includes transmitting a message using a calculated MCS value.

In some examplary embodiments, there are provided methods for enhanced resource reservation while accounting for OOB interference detection and mitigation, comprising: by a self-vehicle and in each slot of a C-V2X communication band: checking if TX is planned in a particular slot during a slot duration; if TX is not planned in the particular slot during the slot duration, checking if Listen-Before-Talk (LBT) is currently set and if OOB energy is detected during the LBT period; and if yes, cancelling the transmission and scheduling a one-time allocation, or if LBT is not currently set and if OOB energy is not detected during the LBT period, transmitting at a scheduled time.

In some examples, if TX is not planned in the particular slot during the slot duration, a method includes checking if OOB interference is detected while receiving a receive (RX) message in the particular slot, and if yes, temporarily enabling the LBT.

In some examples, the temporarily enabling the LBT includes enabling the LBT for a period between a 100 mS and 1 second.

In an exemplary embodiment, there is provided a system for mitigating OOB interference in C-V2X transmissions, comprising: a V2X modem for transmitting and receiving messages; an OOB energy detection unit for detecting OOB energy transmitted by a nearby WiFi transmitter inside the C-V2X band; a one-time allocation identification unit for tracking a resources map to identify a one-time allocation; and an enhanced resource reservation algorithm and MCS setting unit for configuring the V2X modem for transmission based on detected OOB energy and the resources map.

In an example, the V2X modem is configured with a calculated resource allocation slot and a MCS value.

In an example, the OOB energy detection unit is configured to receive from the V2X modem an Error Vector Magnitude (EVM) value and powers received in all subchannels.

In an example, the WiFi transmitter transmits in the U-NII-4 band. In an example, the WiFi transmitter transmits in the U-NII-5 band.

### BRIEF DESCRIPTION OF THE DRAWINGS

Non-limiting embodiments of the presently disclosed subject matter are described below with reference to figures attached hereto that are listed following this paragraph. Identical structures, elements or parts that appear in more than one figure may be labeled with the same numeral in the figures in which they appear. The drawings and descriptions are meant to illuminate and clarify embodiments disclosed herein, and should not be considered limiting in any way.

FIG. 1A illustrates the V2X spectrum allocation in the US;

FIG. 1B illustrates the OOB interferences in the V2X spectrum;

FIG. 1C illustrates schematically a scenario in which vehicles are impacted by WiFi interference;

FIG. 2 illustrates a block diagram of an enhanced C-V2X system with OOB interference detection and mitigation;

FIG. 3A illustrates a flow chart of a method for Modulation Coding Scheme (MCS) setting with OOB detection and mitigation;

FIG. 3B illustrates a flow chart of a method for enhanced resource reservation with OOB detection and mitigation;

FIG. 4A illustrates a flow chart of an OOB interference detection unit;

FIG. 4B illustrates a flow chart of a one-time allocation identification unit;

FIG. 5 illustrates an example of an OOB interference mitigation operation.

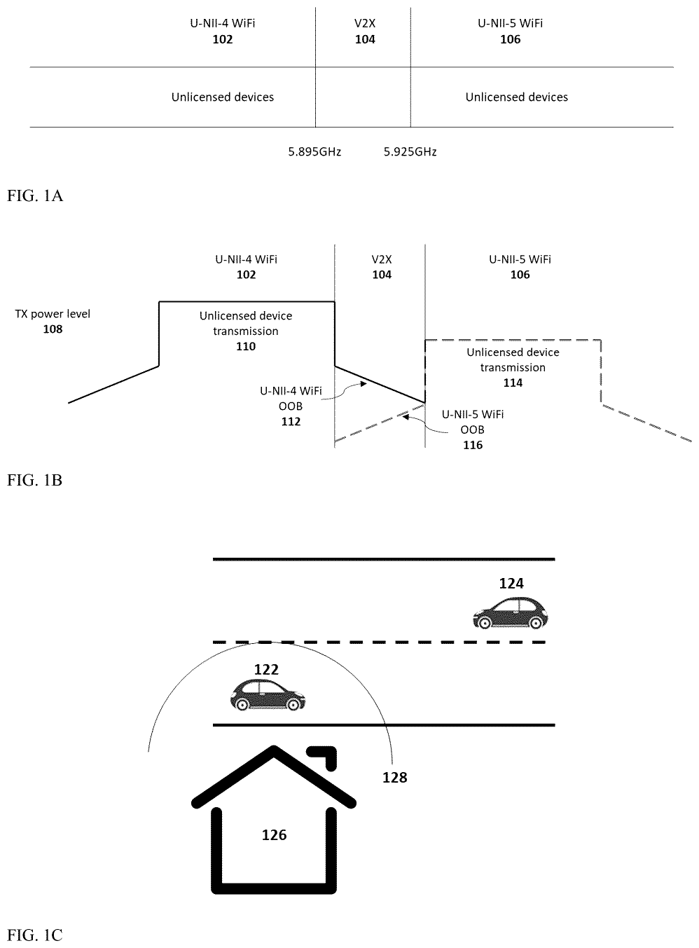

### DETAILED DESCRIPTION

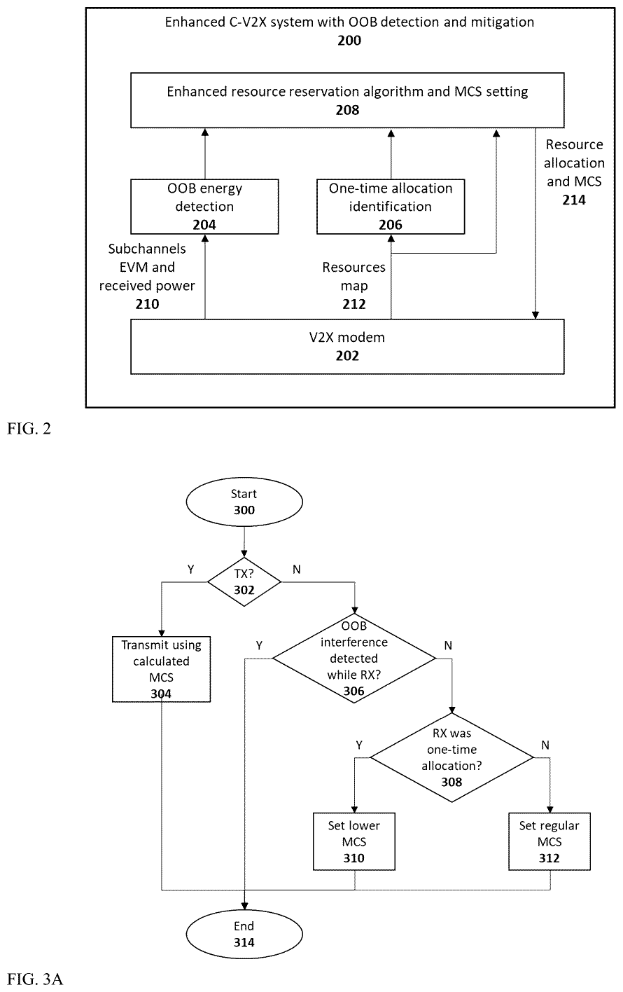

FIG. 2 illustrates a block diagram of an “enhanced” C-V2X system (apparatus) 200 disclosed herein. System 200 is “enhanced” vs known C-V2X systems in that it includes components and functions for OOB detection and mitigation. System 200 comprises a V2X modem unit 202 for transmitting and receiving messages, an OOB energy detection unit 204 for detecting if a nearby WiFi transmitter 128 has emitted strong (e.g. over 5 dB above the thermal noise) OOB 112 inside V2X band 104, a one-time allocation (of a slot for transmission) identification unit 206, and an enhanced resource reservation algorithm and MCS setting unit 208.

In use, unit 204 receives from modem 202 an Error Vector Magnitude (EVM) value and values of powers received in each subchannel. The EVM is a common known-art criterion for noise level. Modem unit 202 provides a resources map 212 to the one-time allocation identification unit 206, which tracks the resources map to identify one-time allocation. In addition to one-time allocation identification, unit 206 can be extended (with new capabilities/functions beyond the standard) to a field to indicate nearby interference, i.e. if a new field indicating nearby WiFi interference needs to be added to the V2X message standard—SAE J2735/1. The resources reservation algorithm and MCS setting unit 208 receives the results of units 204 (i.e OOB energy calculated from subchannel modulated symbols) and 206 as well as resources map 212 from modem 202. Unit 208 then configures the modem with calculated resource allocation and MCS values 214.

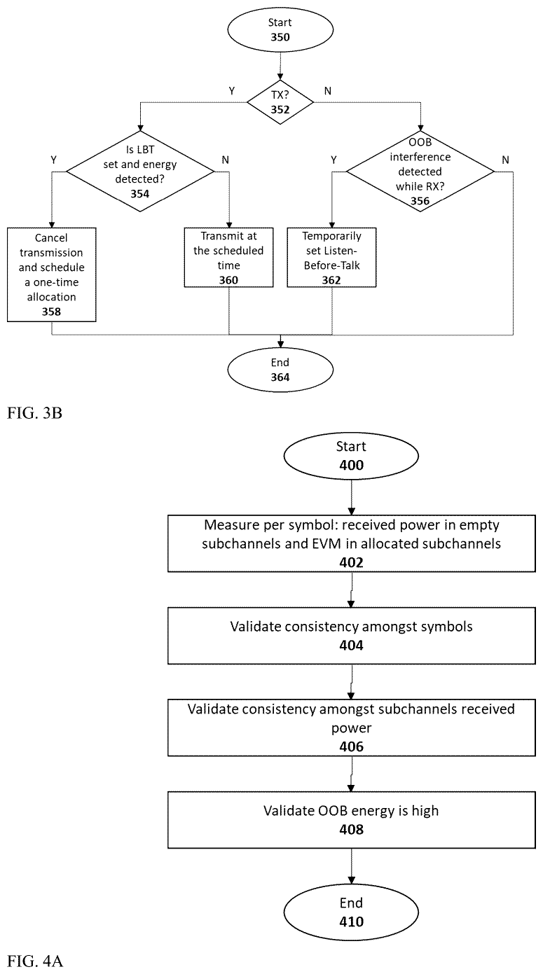

FIG. 3A illustrates a flow chart of a method for MCS setting with OOB detection and mitigation. The final result is control of a used MCS value. The operation is performed in the resource reservation algorithm and MCS setting unit 206 of a self-vehicle, continuously for every slot. The operation begins at step 300, either transmit (TX) or receive (RX). The slot duration is 1 millisecond (mS) for LTE-V2X, or 0.25 mS, 0.5 mS, or 1 mS for NR-V2X. Next, step 302 checks if transmission is planned. If yes, at step 304, the transmission is performed using a MCS value calculated and configured by unit 208 above. If the check of step 302 is negative, i.e. if TX is not planned for the particular slot (No), the operation continues from step 306, which checks if unit 204 detected OOB interference while receiving a RX message in a C-V2X slot. If yes, the operation ends at step 314, i.e. no further actions are needed for this slot, since the transmission took place. If the check of 306 is negative (i.e. GOB interference is not detected) the operation continues from step 308, which checks if the RX message received in step 306 is a one-time allocation. If no, a regular MCS value (as defined by the relevant deployment profile, which is a specific profile standardized per country) is set for the next transmission at step 312, and the operation then ends at step 314. If yes, the transmitting vehicle is suffering from GOB interference, and operation continues from step 310. The next transmission will use a lower MCS value to increase the resilience to noise. Here, “lower” means lower than the value that is supposed to be used according to the regional profile (i.e. the standard). Next, the operation for the slot ends at step 314.

FIG. 3B illustrates a flow chart of a method for enhanced transmission resource reservation. Here, “enhanced” refers to the fact that the reservation is altered in presence of OOB interference. Instead of a semi-static reservation scheme, the resources are changed dynamically with OOB interference detection and mitigation. The final result is control (change) of a reserved TX transmission slot (resource). As in FIG. 3A, the operation is performed in the resource reservation algorithm and MCS setting unit 206 of a self-vehicle, continuously for every slot. The operation begins at step 350t, similar to step 300. Next, step 352 checks if transmission is planned. If yes, step 354 checks if Listen-Before-Talk (LBT) is enabled and if OOB energy detected during the LBT period. If all conditions are true, then the operation continues from step 358 in which the planned transmission is canceled and a one-time allocation is scheduled instead. The transmission cancellation mitigates WiFi interference from a nearby WiFi transmitter (i.e. WiFi transmission in the adjacent band that created the OOB interference), since the planned C-V2X transmission in the particular slot would have interfered with both C-V2X transmission and ongoing WiFi transmission in the adjacent U-NII-4 band, causing WiFi packet retransmission and creating an additional opportunity for collision between WiFi and V2X. The same transmitter would have to retransmit if the first packet was interrupted. In addition, the one-time allocation will reveal to nearby vehicles that the self-vehicle is impacted by GOB interference, which would allow those nearby vehicle to mitigate their transmission (i.e. reschedule the expected transmission and therefore avoid collision). Next, the operation ends in step 364.

If check 354 results in No, then in step 360 the transmission takes place at the scheduled (planned) transmission time (i.e. reserved resource).

If the check of step 352 is negative, when TX is false i.e. if TX is not planned in the particular slot during the slot duration, the operation continues from step 356, which checks if unit 204 detected OOB interference while receiving a RX message in a C-V2X slot. If yes, the vehicle is within WiFi interference range, and the operation continues to step 362 in which LBT is temporarily set. The setting duration is typically between a single cycle (100 mS) and several cycles (1 second). The enablement is temporary, because LBT increases the probability of C-V2X resource collision based on false noise measurement. Next, the operation ends at step 364. If the check of 356 is negative (i.e. GOB interference is not detected) the operation ends at step 364.

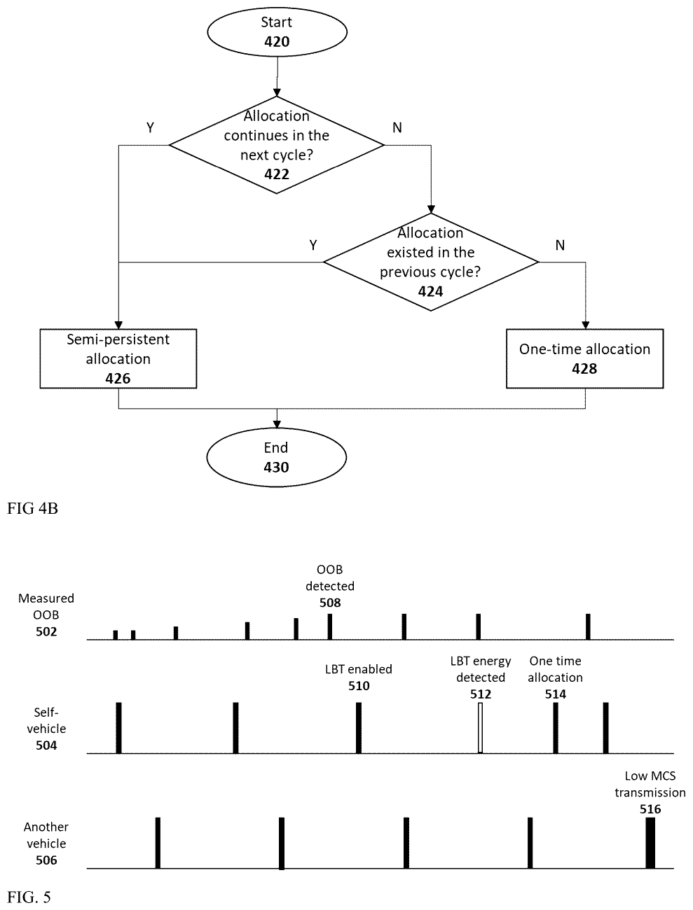

FIG. 4A illustrates a flow chart of the operation of OOB energy detection unit 204, which performs step 306. The operation begins in step 400, after every invocation of step 306, which is in every received slot. Next, in step 402, received power in empty subchannels and EVM in allocated subchannels is measured per symbol. Subchannel allocation is indicated in the PSCCH control channel. The OOB energy measurement is different, depending on the subchannel allocation. If allocated, the OOB energy is measured as a noise added to the received signal, for example as EVM. If the subchannel is not allocated, the received power is measured. Next, the operation continues from step 404, in which consistency amongst symbols is validated. While the overall symbol received power measurement can vary, for example, if the WiFi transmission started or ended, it cannot be erratic, meaning the measurement of each symbol is entirely different. The scheme compares the measurements of all pairs of adjacent symbols. An energy difference higher than a threshold, for example 5 dB, between more than 2 symbols indicates invalid symbol consistency. Next, the operation continues from step 406, in which the consistency amongst subchannels received power (received and measured in different subchannels in step 402) is validated. In an example, consistency is validated by applying a linear fit. The variance of a single subchannel from the fitted line should be low (e.g. less than 3 dB) and the highest energy of the fitted line should be at the edge of the WiFi band (i.e. the highest frequency allocated to U-NII-4 band, which is the lowest frequency allocated for V2X), to ignore random noises not caused by WiFi. All WiFi transmission signals are filtered, and the interference is always higher when closer to the WiFi band. Next, the operation continues to step 408 which validates that the OOB energy is high. For example, if the sensitivity is −96 dBm, then only if the OOB energy is higher than −91 dBm, the OOB energy is considered an interferer. Note that these values are exemplary, and that the OOB energy may be considered an interferer for example starting at −93 dBm sensitivity. That will prevent weak noises from deferring V2X messages, thus limiting the mitigation only when a significant degradation in the V2X reception range is expected. In this context, “weak” noises are noises below “strong”, i.e. less than 5 dB above the thermal level. Significant degradation starts at 3 dB. If the high noise level is validated, then OOB energy is detected. Next, the operation ends at step 410.

FIG. 4B illustrates a flow chart of a one-time allocation identification. It describes the operation of one-time allocation identification unit 206, which performs step 308. C-V2X does not have an explicit indication of one-time allocation, hence allocation tracking over cycles is needed. C-V2X only contains an indication that the allocation will change in the next cycle. The operation begins at 420 after each received slot. Next, in step 422, it is checked if the allocation continues in the next cycle, as indicated by a dedicated flag inside the PSCCH control channel. If yes (the allocation continues in the next cycle), the operation continues to step 426, in which the allocation is identified as “semi-persistent” (in contrast with one-time allocation which, as implied by its name, does not span across multiple cycles, and operation ends at step 430. If check 422 is negative (i.e. the allocation ends in this cycle), the operation continues to step 424 to check when the allocation started. If the allocation existed in the previous cycle, then it is not a one-time allocation, and the operation continues from step 426. If the allocation did not exist in the previous cycle, the operation continues from step 428. The result of step 428 is used in the operation described with reference to FIG. 5. Next, the operation ends in step 430.

FIG. 5 illustrates an example of an OOB interference mitigation operation. Three signals are shown. The top signal 502 is the OOB interference from an indoor WiFi access point as received by the self-vehicle. The middle signal 504 is the self-vehicle transmission. The bottom signal 506 is the transmission of another vehicle, which is within the range of the self-vehicle but is not observing the GOB interference of the WiFi device.

The WiFi device transmits messages at arbitrary times. Both the self-vehicle and the other vehicle transmit V2X message periodically. At the beginning of the example, GOB received power is low, and both vehicles are not impacted by interferences. The self-vehicle is getting closer to the WiFi access point, and the OOB received energy is increasing. At received WiFi message 508, the OOB received energy is validated as interfering. LBT is enabled for self-vehicle reception 510. Yet, there was no WiFi transmission before transmitting 510, so the transmission took place at the designated time, and the other vehicle was not made aware of an interference. In the next self-vehicle planned transmission 512, the WiFi transmitted as well. LBT energy was measured, and the transmission was canceled. A one-time allocation 514 was scheduled. The transmission of 514 indicates to the other vehicle that the self-vehicle is impacted by the WiFi, and it uses low MCS in its next transmission 516.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

Some stages of the aforementioned methods may also be implemented in a computer program for running on a computer system, at least including code portions for performing steps of a the relevant method when run on a programmable apparatus, such as a computer system or enabling a programmable apparatus to perform functions of a device or system according to the disclosure. Such methods may also be implemented in a computer program for running on a computer system, at least including code portions that make a computer execute the steps of a method according to the disclosure.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

What is claimed is:

1. A method for setting a modulation coding scheme (MCS) value while accounting for out-of-band (OOB) interference detection and mitigation, comprising: by a self-vehicle and in each slot of a cellular vehicle-to-everything (C-V2X) communication band:
checking if transmission (TX) is planned in a particular slot during a slot duration;
if TX is not planned in the particular slot during the slot duration, checking if OOB interference is detected while receiving a message in the particular slot;
if OOB interference is not detected while receiving the message in the particular slot, checking if the received message is a one-time allocation; and,
if the received message is a one-time allocation, setting a MCS value lower than a regular MCS value to increase the resilience to the OOB interference.

2. The method of claim 1, wherein if TX is planned in the particular slot during the slot duration, transmitting a message using a calculated MCS value.

3. The method of claim 1, wherein if the received message is a one-time allocation, setting the regular MCS value.

4. The method of claim 1, wherein the OOB interference is caused by WiFi transmission in the U-NII-4 band.

5. The method of claim 1, wherein the OOB interference is caused by WiFi transmission in the U-NII-5 band.

6. A method for enhanced resource reservation while accounting for out-of-band (OOB) interference detection and mitigation, comprising: by a self-vehicle and in each slot of a cellular vehicle-to-everything (C-V2X) communication band:
checking if transmission (TX) is planned in a particular slot during a slot duration;
if TX is not planned in the particular slot during the slot duration, checking if Listen-Before-Talk (LBT) is currently set and if OOB energy is detected during the LBT period; and
if yes, cancelling the transmission and scheduling a one-time allocation, or if LBT is not currently set and if OOB energy is not detected during the LBT period, transmitting at a scheduled time.

7. The method of claim 6, wherein if TX is not planned in the particular slot during the slot duration, checking if OOB interference is detected while receiving a receive (RX) message in the particular slot, and if yes, temporarily enabling the LBT.

8. The method of claim 6, wherein the temporarily enabling the LBT includes enabling the LBT for a period between a 100 mS and 1 second.

9. The method of claim 6, wherein the OOB interference is caused by WiFi transmission in the U-NII-4 band.

10. The method of claim 6, wherein the OOB interference is caused by WiFi transmission in the U-NII-5 band.

11. A system for mitigating out-of-band (OOB) interference in cellular vehicle-to everything (C-V2X) transmissions, comprising:
a V2X modem for transmitting and receiving messages;
an OOB energy detection unit for detecting OOB energy transmitted by a nearby WiFi transmitter inside the C-V2X band;
a one-time allocation identification unit for tracking a resources map to identify a one-time allocation; and
an enhanced resource reservation algorithm and MCS setting unit for configuring the V2X modem for transmission based on detected OOB energy and the resources map.

12. The system of claim 11, wherein the V2X modem is configured with a calculated resource allocation slot and a MCS value.

13. The system of claim 11, wherein the OOB energy detection unit is configured to receive from the V2X modem an Error Vector Magnitude (EVM) value and powers received in all subchannels.

14. The system of claim 11, wherein the WiFi transmitter transmits in the U-NII-4 band.

15. The system of claim 11, wherein the WiFi transmitter transmits in the U-NII-5 band.
